(19) United States
(12) Patent Application Publication
(10) Pub. No.: US 2015/0178326 A1
(43) Pub. Date: Jun. 25, 2015

(54) HYDROCARBON DATA MANAGEMENT SOFTWARE EXECUTION SYSTEM

(71) Applicants: James Henry McKell, Houston, TX (US); Joseph Spivey, Cypress, TX (US)

(72) Inventors: James Henry McKell, Houston, TX (US); Joseph Spivey, Cypress, TX (US)

(73) Assignee: CHEVRON U.S.A. INC., San Ramon, CA (US)

(21) Appl. No.: 14/139,561

(22) Filed: Dec. 23, 2013

(51) Int. Cl. G06F 17/30

(52) U.S. Cl. CPC G06F 17/30289; G06F 17/30477

(57) ABSTRACT

A hydrocarbon production tracking system and method of execution are disclosed. Generally, the system includes a plurality of processing units useable to execute a hydrocarbon production tracking system application that processes and tracks historical data regarding hydrocarbon production assets via a hydrocarbon production asset database including field operations data and formulas modeling field operations an organization over a lifetime of each of a plurality of hydrocarbon production assets associated with the organization. The hydrocarbon production asset database includes at least one covering index over the assets, and the queries to the database are handled by a plurality of processing units managed by a coordinating process.

### BACKGROUND

Large-scale hydrocarbon production systems typically include a variety of types of hydrocarbon production equipment, such as wells, reservoirs, tanks, platforms, and other harvesting, transport, and processing equipment. Various software systems exist for tracking hydrocarbons from production and transport to sales and recognition of revenue therefrom (e.g. Energy Components (EC) software suite, Tieto® Corporation, Helsinki, Finland). Such software systems generally monitor hydrocarbon production locations, processing locations, transport systems, and sales channels to ensure unified tracking to ensure accurate reporting of hydrocarbon operations. This includes tracking each asset included in such systems, including each of the wells, reservoirs, tanks, platforms, or other energy producing, transporting, etc. systems that are included in a particular entity's production system, over the lifetime of each such asset.

Because of the very large scale of operations of a hydrocarbon production organization, hydrocarbon production organizations using such hydrocarbon tracking software typically include databases used in that software, including in the Energy Components software suite, that are large and complex. Furthermore, there are various types of information that are typically required to be tracked by such software systems, for fluid accounting across operations between a well face and a custodial transport point (e.g., a LACT meter, BOL, etc.). This data can include, for example, field meter data, well test results, lab analysis, LPO, daily well data, including temperature, pressure, and volumes, as well as tank volumes and chemical inventories.

Furthermore, and beyond the large number of types of data, it is noted that the data actually captured in such a system is typically retained for a substantial amount of time. For example, because current operational data is often compared to pre-existing data for purposes of monitoring historical performance or for purposes of generating reports comparing or incorporating historical data, this data is captured and held over the life of each asset, typically for many decades. Still further, because some data is intended to describe, via a model, a type of activity in a well, reservoir, or tank, many types of data are stored as formulas derived from other values, rather than as values themselves. As such, when such data is retrieved, the underlying values must then be accessed and the formula-based value recomputed.

Typically, such hydrocarbon tracking software includes a database for storage of data, such as a SQL database of some type. However, based on the size and structure of such a database that includes data collected over the life of many assets, and the complexity of some queries and/or reports generated from that database, the performance of the hydrocarbon tracking software in responding to queries, using typical computing hardware and database configurations is very poor and can render the software largely unusable based on the time required to fulfill such queries. Additionally, because field operations data includes many formulas that are retrieved and must be resolved for each query, traditional query processing techniques are inadequate for complex analyses of field operations data, and in particular for tracking of hydrocarbon assets throughout a production environment.

### SUMMARY

In summary, the present disclosure relates to execution of large-scale hydrocarbon production asset tracking software, and in particular to techniques and systems for managing data update and reporting using such software. The present application discusses techniques for at least partially optimizing database and computing system structures such that both data update and query processing can be performed efficiently (e.g., within a reasonable amount of time).

In a first aspect, a hydrocarbon production tracking system is disclosed. The system includes a computing system including a plurality of processing units and a memory communicatively connected to the plurality of processing units. The memory stores computer-executable instructions which, when executed, cause the computing system to execute a hydrocarbon production tracking system application. The hydrocarbon production tracking system application is executable to process and track historical data regarding a plurality of hydrocarbon production assets, and receive and process queries received at the computing system. The system further includes a hydrocarbon production asset database communicatively coupled to the plurality of processing units, the hydrocarbon production asset database including field operations data and formulas modeling field operations an organization over a lifetime of each of a plurality of hydrocarbon production assets associated with the organization. The computing system is configured such that at least one of the plurality of processing units executes a coordinating process and a remaining plurality of the processing units are configured to respond to the queries, wherein the queries are associated with the hydrocarbon production asset database. The hydrocarbon production asset database includes at least one covering index, the covering index useable by the hydrocarbon production tracking system application to respond to the queries received at the computing system.

In a second aspect, a method of executing a hydrocarbon production tracking system application on a computing system is disclosed. The method includes receiving a query at the hydrocarbon production tracking system application executing on a computing system, and splitting, via the hydrocarbon production tracking system application, the query into a plurality of sub-tasks. The method also includes assigning the sub-tasks to each of a plurality of processing units of the computing system. The method further includes applying the sub-tasks to data included in a hydrocarbon production asset database, the hydrocarbon production asset database including field operations data and formulas modeling field operations an organization over a lifetime of each of a plurality of hydrocarbon production assets associated with the organization, the hydrocarbon production asset database including at least one covering index useable by the hydrocarbon production tracking system application to respond to the queries received at the computing system. The method includes compiling results from each of the plurality of subtasks into results of the query, and generating one or more reports based on the results of the query.

In a third aspect, a computer-readable storage medium comprising computer-executable instructions is disclosed which, when executed, performs a method of executing a hydrocarbon production tracking system application on a computing system. The method includes receiving a query at the hydrocarbon production tracking system application executing on a computing system, and splitting, via the hydrocarbon production tracking system application, the query into a plurality of sub-tasks. The method also includes assigning the sub-tasks to each of a plurality of processing units of the computing system. The method further includes applying the sub-tasks to data included in a hydrocarbon production asset database, the hydrocarbon production asset database including field operations data and formulas modeling field operations an organization over a lifetime of each of a plurality of hydrocarbon production assets associated with the organization, the hydrocarbon production asset database including at least one covering index useable by the hydrocarbon production tracking system application to respond to the queries received at the computing system. The method includes compiling results from each of the plurality of subtasks into results of the query, and generating one or more reports based on the results of the query.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example network in which aspects of the present application can be implemented;

FIG. 2 illustrates an example of parallel query processing useable in connection with the present disclosure;

FIG. 3A illustrates an example of a hydrocarbon production tracking system, according to an example embodiment;

FIG. 3B illustrates an example of a hydrocarbon production asset database useable in a hydrocarbon production tracking system, according to an example embodiment;

FIG. 4 illustrates an electronic computing device useable to implement aspects of the present disclosure;

FIG. 5 is a flowchart of a method of executing a hydrocarbon production tracking system application on a computing system, according to an example embodiment;

FIG. 6 is a chart illustrating an overall effect of parallelism and covering indices on processing of queries on a hydrocarbon production asset database, in an experimental configuration;

FIG. 7 is a chart illustrating an effect of parallelism and covering indices over slowest, average, and fastest scenarios, further defining the experimental configuration of FIG. 6; and

FIG. 8 is a chart illustrating an effect of parallelism and covering indices over slowest, average, and fastest scenarios, illustrating a portion of the chart of FIG. 7.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to methods and systems for improving performance of a hydrocarbon production tracking system application in a hydrocarbon production tracking system. In example embodiments, the present disclosure describes use of parallelism and covering indices to address previously unaddressed performance issues in hydrocarbon production tracking systems. Because, in such systems, data is continually updated and intended for long-term storage but is less frequently queried, performance issues relative to such queries have been known, but remain largely unaddressed. Furthermore, because use of indices typically reduce performance of frequently-updated databases (since such indices have to be updated frequency in cases of frequent data updates), and because many data records in a hydrocarbon production asset database are represented as formulas rather than data, hydrocarbon production tracking systems typically do not make frequent use of data indices, or at least indices extending across all data. In the context of the present disclosure, more frequent, more complex queries requiring both data access and resolution of formulas included in the database result in performance issues that are addressed herein using techniques not previously applied to such field operations data.

Although the EC software suite has been mentioned as one example of a hydrocarbon production tracking system applications, it is emphasized that any type of hydrocarbon production tracking system applications could be used in connection with the methods and systems described herein. Accordingly, the present disclosure relates generally to a hydrocarbon production tracking system, including any of a variety of types of applications that can be configured to monitor field operations data.

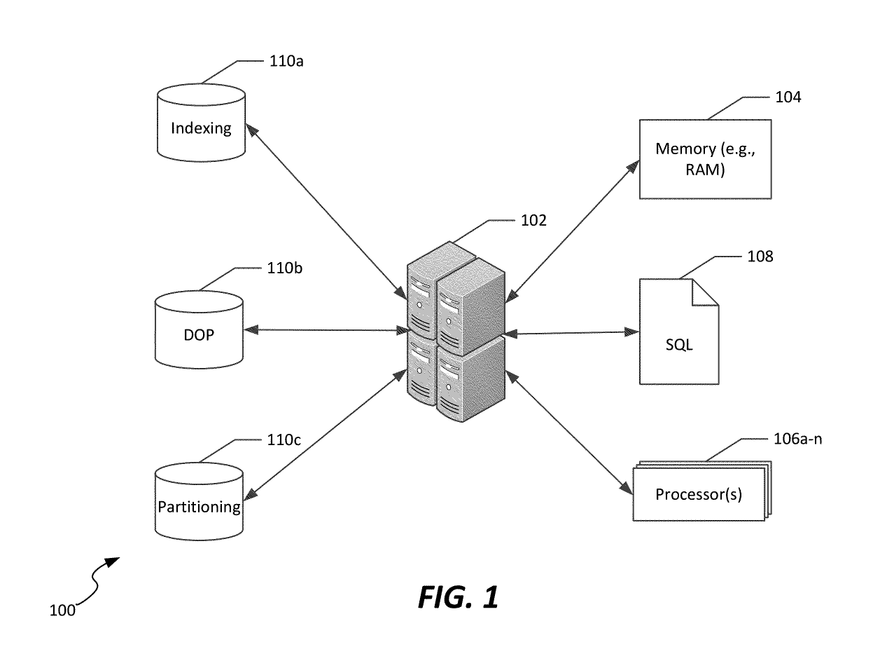

Referring now to FIG. 1, an example network 100 is disclosed in which aspects of the present application can be implemented. The example network 100 represents a possible arrangement in which a hydrocarbon production tracking system application can be implemented, according to some embodiments discussed herein. In the embodiment shown, the network 100 includes a hydrocarbon production tracking system 102. The hydrocarbon production tracking system 102 generally executes a hydrocarbon production tracking system application to support tracking of and reporting based on data tracked in a hydrocarbon production asset database, as further discussed below in connection with the subsequent features. The hydrocarbon production tracking system 102 can be implemented using one or more networked computers, such as a database server, an application server, a web server, or combinations thereof.

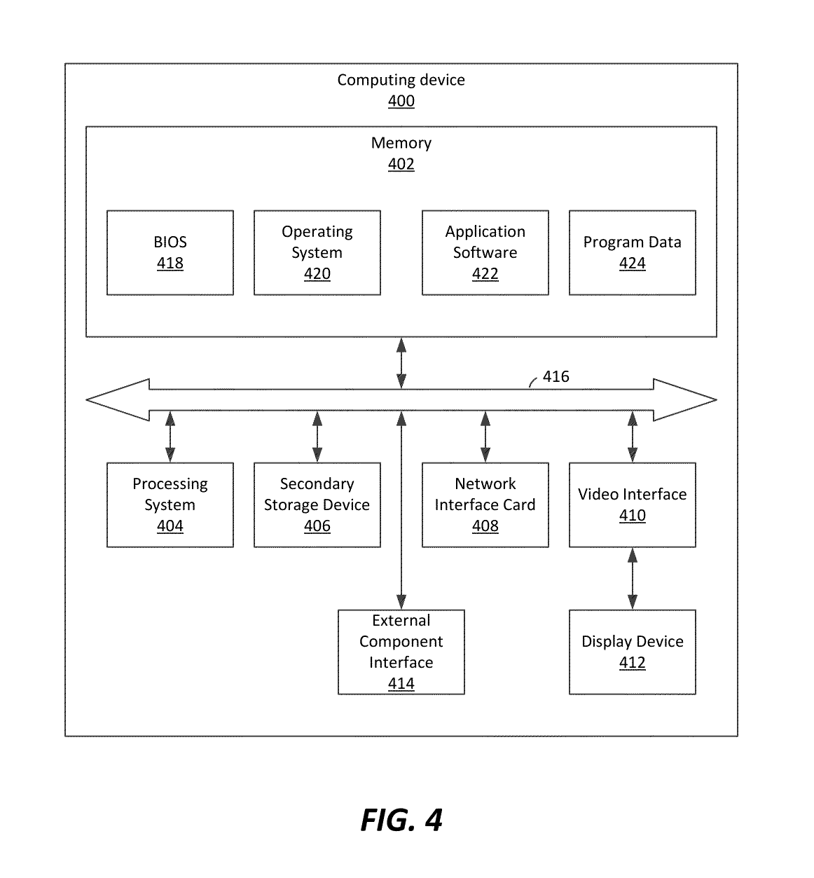

In the embodiment shown, the hydrocarbon production tracking system 102 includes a memory 104 and a plurality of processing units 106a-n, shown as microprocessors. The memory 104 can include, for example, a Random Access Memory (RAM), Read-Only Memory (ROM), as well as any of a variety of other disk storage memory devices. Example device configurations are discussed further below in connection with FIG. 4.

In the embodiment shown, the processing units 106a-n reside within the hydrocarbon production tracking system 102, and are configurable for parallel execution. In other words, each of the processing units 106a-n can be assigned a different work thread and tasks for execution. In various embodiments, the processing units 106a-n can correspond to physical and/or logical microprocessors.

As generally shown in FIG. 1, the hydrocarbon production tracking system 102 receives one or more queries, such as SQL query 108, for execution on a hydrocarbon production asset database. In various embodiments, the SQL query 108 can be issued from a remote application or remote computing system, such as a desktop or mobile computing device communicatively connected to the hydrocarbon production tracking system 102, e.g., via the Internet or some other communication network.

In example embodiments, the SQL query 108 is processed by the hydrocarbon production tracking system 102. As previously explained, existing configurations using a hydrocarbon production asset database generally have substantial delays in returning query results. However, as illustrated in FIG. 1, data managed by the hydrocarbon production tracking system 102 may have a plurality of techniques applied, including indexing 110a, data object parallelism 110b, and partitioning 110c.

In connection with the present disclosure, indexing 110a refers to a technique useable in connection with database technologies to avoid full table scans within a database, and are used to optimize performance of common views or tables that are queried, reducing the time required to retrieve data. As noted above, indexing 110a can reduce data read times, but generally have an adverse effect on data write operations due to the requirement of indexing the newly-written data if written to an indexed table of a database.

Data-object parallelism 110b generally corresponds to carrying out multiple operations simultaneously, thereby decreasing the time required to perform a particular task. Data-object parallelism 110b adds complexity to database processing, but can also reduce data read times. In some embodiments discussed below, a hydrocarbon production asset database can be configured to isolate poorly performing views and simultaneously process segments of a database query that are typically poor performers.

Partitioning 110c corresponds to logical separation of data into data commonly used together. As noted above, many views within the hydrocarbon production tracking system 102 are based on calculations of multiple data elements; as discussed herein, partitioning 110c allows for separation of a database logically to ensure that such data having interdependencies are located together, while minimizing occurrences where formulas or queries require data from different partitions. Furthermore, the partitions allow for quicker query processing based on being able to apply a query to less than an entire database.

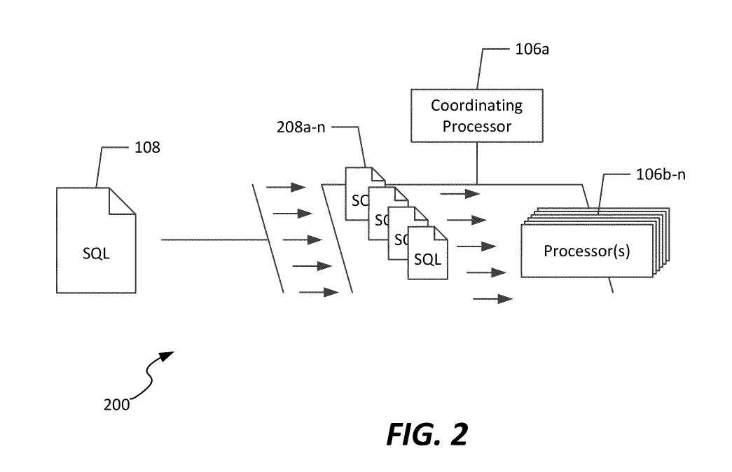

Referring now to FIG. 2, an example of a parallel query processing arrangement 200 is shown, and which is useable in connection with the hydrocarbon production tracking system 102 of the present disclosure. In the embodiment shown a plurality of processing units 106a-n are not directly provided the SQL query 108, but rather that query is separated into a plurality of sub-queries 208a-n. These sub-queries, or sub-tasks, are logically separate, but the results of such queries are compiled to generate overall results.

In the example shown, each of the processing units 106a-n are not provided separate tasks; rather, one or more of the processing units (shown as processing unit 106a) is used to manage a coordinating process, and remaining processing units (shown as processing units 106b-n) are used to process such sub-tasks. Although a single coordinating processing unit is shown in this example, it is recognized that two or more coordinating processing units could be used, in alternative embodiments.

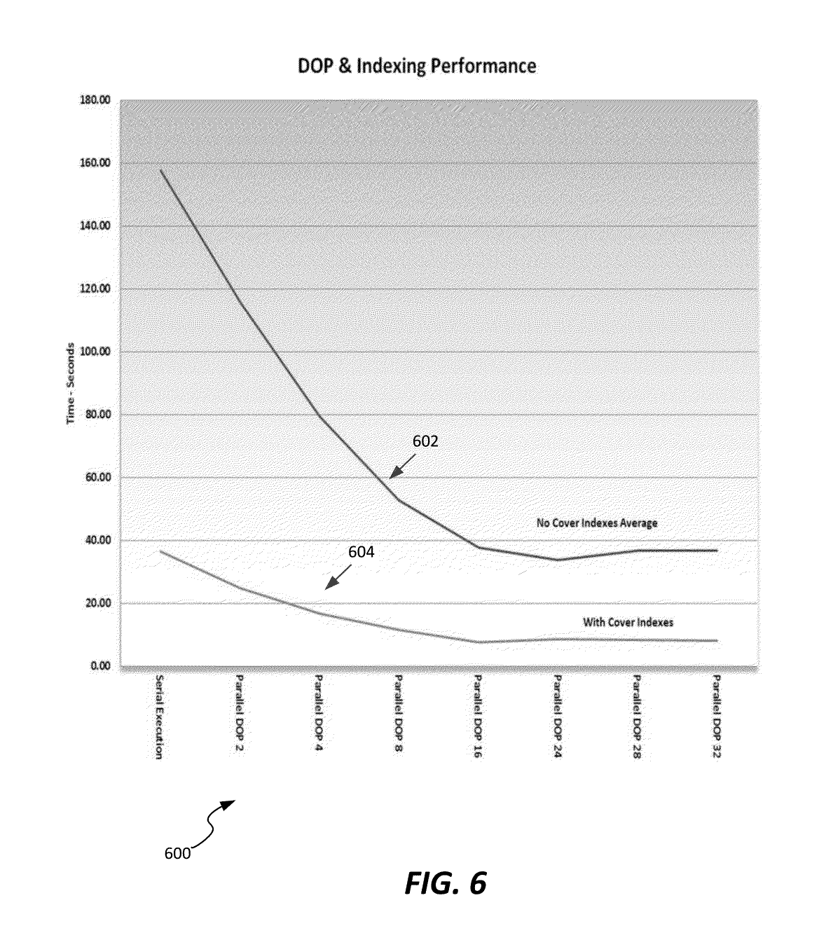

In various embodiments, different numbers of processing units could be used in connection with the parallel sub-task processing discussed herein. In example embodiments, up to 16 different logical processing units are used. In alternative embodiments, 32 or more processing units can be used. Effects of use of different numbers of processors to attend to parallel sub-tasks are discussed in further detail below in connection with FIGS. 6-8.

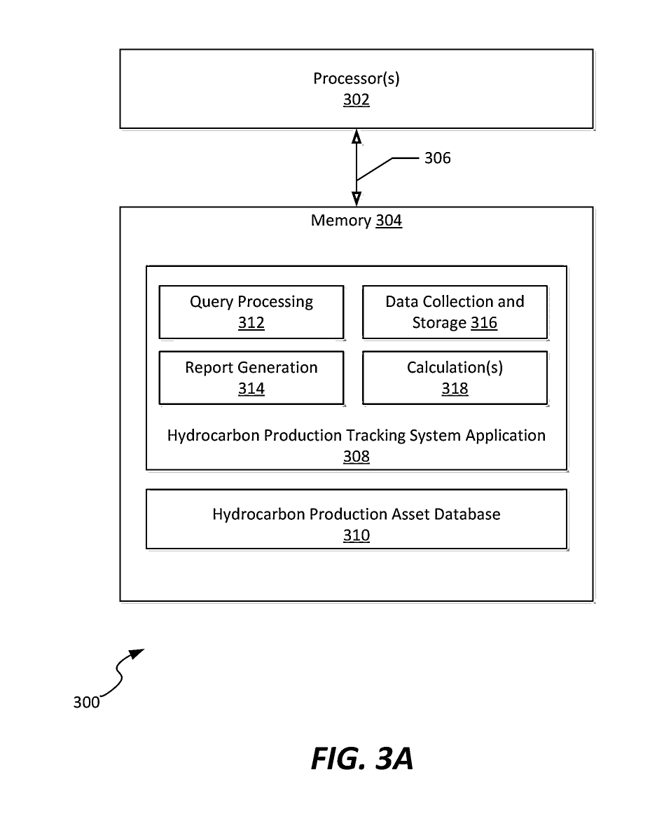

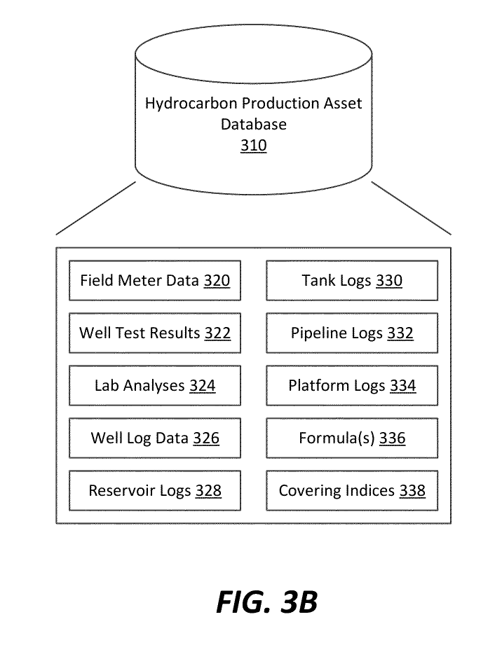

Referring now to FIGS. 3A-3B, details regarding an example hydrocarbon production tracking system 300 are described. The hydrocarbon production tracking system 300 can be used, for example, as the hydrocarbon production tracking system 102 of FIG. 1.

In the embodiment shown in FIG. 3A, the hydrocarbon production tracking system 300 includes a plurality of processing units 302 communicatively connected to a memory 304, e.g., via a data bus 306. The memory 304 stores a hydrocarbon production tracking system application 308 and a hydrocarbon production asset database 310. Generally, the hydrocarbon production tracking system application 308 manages data storage and communication between remote computing systems (including applications executing thereon) and the hydrocarbon production asset database 310.

In the embodiment shown, the hydrocarbon production tracking system application 308 includes a query processing component 312, a report generation component 314, a data collection and storage component 316, and a calculations component 318. Other components or organizations of components and/or functionality within the hydrocarbon production tracking system application 308 could be included as well.

In the example embodiment shown, the query processing component 312 receives queries from remote users or computing systems, accesses the hydrocarbon production asset database 310, and compiles results for use by such remote systems. In the example provided herein, the query processing component 312 can include a coordinating process assigned to a processing unit to perform a coordination and subtask generation process by which queries can be broken down into subcomponents for execution on the hydrocarbon production asset database 310.

In the example embodiment shown, the report generation component 314 is configured to generate reports based on one or more sets of query results as determined by the query processing component 312. In various embodiments, the report generation component 314 is configured to generate one or more specific types of reports, such as, for example, an injection production profile, a Hall plot, a WaterFlood surveillance, an asset trend report, a fuel use report, or a nomination schedule. Other types of reports are possible as well. In various embodiments, the report generation component 314 generates one or more reports based on a large number of assets and over a large amount of time relative to those assets (e.g., reviewing trends over all or nearly all of a lifetime of that asset) with real-time or near real-time data availability.

In the embodiment shown, the data collection and storage component 316 manages receipt and storage of data, such as field operations data, in the hydrocarbon production asset database 310. The data collection and storage component 316 manages storage of data across one or more database partitions and in areas which are logically interrelated, e.g., in a common table, or within adjacent tables. In some embodiments, the data collection and storage component 316 updates indices that are included in the hydrocarbon production asset database 310, including one or more covering indices useable to ensure data availability to the query processing component 312.

In the embodiment shown, the calculations component 318 manages calculations that are performed as part of one or more common views that are generated in response to queries. The calculations component 318 can, in some embodiments, generate intermediate data results used within query results and reports, including using data stored across tables and/or partitions within the hydrocarbon production asset database 310. As such, the calculations component 318 can be assigned to one or more processing units of the system 300, for example to allow for parallel processing with other query tasks. This reduces the delay occurring in query processing based on separate calculations that are required, since such functions are typically processing-intensive operations.

In alternative embodiments, other types of field operations data tracking applications could be used. The present disclosure contemplates execution of various types of engineering analytics that utilize complex query processing over hydrocarbon asset lifetimes in one or more different deployed applications across a network or overall system of hydrocarbon production assets.

FIG. 3B illustrates an example of a hydrocarbon production asset database 310 useable in a hydrocarbon production tracking system 300 of FIG. 3A. In the example shown, the hydrocarbon production asset database 310 includes various data records, associated with field operations data. The data records generally include information about volumes of hydrocarbons present at various stages of a hydrocarbon production process. For example, in some embodiments the hydrocarbon production asset database 310 can include, for example, field meter data 320, well test results 322, lab analyses 324, well log data 326, reservoir logs 328, tank logs 330, pipeline logs 332, and platform logs 334. Other data can be stored in the hydrocarbon production asset database 310 as well. Generally, data associated with each such asset, which can include zonal, reservoir, and well head initial volume information or other types of performance data, is retained over a lifetime of each type of asset in a hydrocarbon production environment, such as wells, platforms, reservoirs, pipelines, tanks, and other equipment.

The hydrocarbon production asset database 310 can also include, for example a plurality of formulas 336 and one or more covering indices 338. The plurality of formulas 336 typically represent modeled behaviors of a collection of one or more hydrocarbon assets, including the volumes noted above as hydrocarbons are extracted and transported. Additionally, in the example shown, the covering indices 338 are used across each of a plurality of types of data assets to reflect the different possible combinations of data used in typically generated reports discussed above in connection with FIG. 3A. The covering indices 338 provide a mechanism for improved query processing to obtain data more efficiently from the hydrocarbon production asset database 310.

Referring now to FIG. 4, a schematic illustration of an example computing system in which aspects of the present disclosure can be implemented. The computing system 400 can represent, for example, a computing system on which hydrocarbon production tracking system 102 could be implemented, or a computing system used to issue queries to the hydrocarbon production tracking system 102.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer-readable storage media capable of storing data and/or instructions. In different embodiments, the memory 402 is implemented in different ways. For example, the memory 402 can be implemented using various types of computer-readable storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more physical or logical processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer-readable storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer-readable storage media. For example, the secondary storage device 406 can include one or more magnetic disks, magnetic tape drives, optical discs, solid state memory devices, and/or other types of computer-readable storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as an LCD display panel, a plasma screen display panel, a touch-sensitive display panel, an LED screen, a cathode-ray tube display, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer-readable storage media and communication media. As used in this document, a computer-readable storage medium is a device or article of manufacture that stores data and/or computer-executable instructions. Computer-readable storage media may include volatile and nonvolatile, removable and non-removable devices or articles of manufacture implemented in any method or technology for storage of information, such as computer readable instructions, data structures, program modules, or other data. By way of example, and not limitation, computer-readable storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer-readable storage media generally includes at least some tangible component on which computer-executable instructions can be stored, and can be included in a computer storage device such as any of the devices discussed above. In some cases, computer-readable storage media are embodied in a non-transitory computer storage device. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

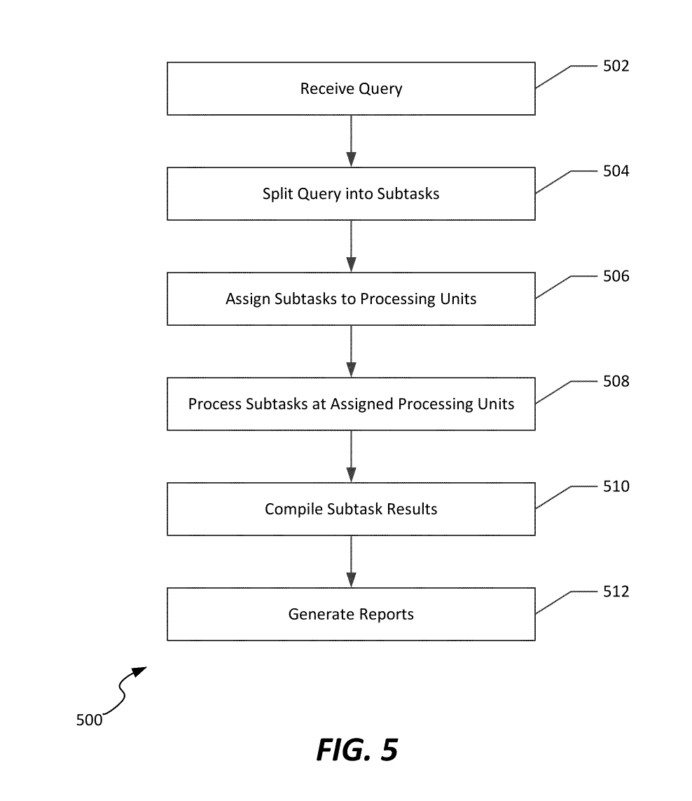

FIG. 5 is a flowchart of a method 500 of executing a hydrocarbon production tracking system application on a computing system, according to an example embodiment. The method 500 can be used in connection with operation of the hydrocarbon production tracking systems 102, 300 as discussed above, and in connection with a database such as the hydrocarbon production asset database 310 of FIG. 3B. In some embodiments, the method 500 is performed by a hydrocarbon production tracking system application, such as application 308 of FIG. 3A.

In the embodiment shown, the method 500 includes a query receipt operation 502, which corresponds to receipt of a query at a hydrocarbon production tracking system. The query receipt operation 502 can correspond to receipt of a query from a user or remote computing system for processing. A query split operation 504 splits the received query into a plurality of subtasks for execution by the hydrocarbon production tracking system. In example embodiments, the query split operation 504 can be performed by the query processing component 312 of FIG. 3A, and includes separating the received query into a plurality of logically discrete tasks.

In the embodiment shown, in an assignment operation 506, each of the logically discrete tasks is assigned to a processing unit. For example, each of the tasks could be separately assigned to a different processing unit. In alternative arrangements (and depending upon the degree of parallelism included in the system), the assignment operation 506 can include assigning sub-tasks to a variety of different processing units based on availability of those processing units, as assigned by a coordinating process occurring on a separate processing unit. A processing operation 508 corresponds to processing of the sub-tasks (e.g., the logically discrete tasks) by the processing units to which they are assigned.

In some embodiments, the assignment operation 506 can assign different queries of the database to different processors for submission to the database; in alternative configurations, the assignment operation 506 can allocate one or more processors to performing calculations defined in the formulas used to model behavior of assets and hydrocarbon production characteristics, or a combination of queries and formula processing. As such, the assignment operation 506 can associate processors to various processing-intensive tasks to improve performance of query and formula processing for field operations data.

In the embodiment shown, a compilation operation 510 compiles the results from each of the completed sub-tasks, for example by the coordinating process, or as instructed by the coordinating process to each of the different processing units that perform the sub-tasks. A report generation operation 512 can, in some embodiments, generate a selected report based on the results, for example any of the reports discussed above (e.g., an injection production profile, a Hall plot, a WaterFlood surveillance, an asset trend report, a fuel use report, or a nomination schedule).

In some embodiments of the present disclosure, the report generation operation 512 can generate reports of various forms. For example, in some cases the report generation operation 512 can generate a formalized report useable for analysis. In alternative embodiments, the report generation operation 512 simply formats data for display within an application (e.g., a browser or special-purpose application executing on a computing system) configured to interface with the hydrocarbon production tracking system application 308.

Referring to FIGS. 6-8, details regarding the use of covering indices and data object parallelism to the hydrocarbon production tracking system discussed herein are shown. Generally, FIGS. 6-8 represent graphs showing effects of different levels of parallelism and effects of such covering indices on query responsiveness. In particular, the graphs of FIGS. 6-8 track time required to execute a query and a number of processing units, or cores, that are in use.

The experiments performed in FIGS. 6-8 are performed on a particular database implemented in the Energy Components (EC) software suite from Tieto Corporation of Helsinki, Finland, on a computing system implemented with 32 processing units, or cores. In the example shown in FIG. 6, a first chart 600 includes an unindexed performance line 602 and an indexed performance line 604. As can be seen in the first chart 600, the more cores applied, the quicker the execution time for both the unindexed performance and indexed performance. It is noted that, once 16 cores is reached, performance generally levels off.

It is further noted that, in the example shown, of the 32 cores in use, one of those cores is given up as a “coordinator” process core (e.g., processor 106a of FIG. 2). In the example embodiments disclosed, the processor used for the coordinating process performs many operations when parallelism is high; accordingly, to further address performance when more than 16 cores are to be used, one or more additional coordinating processor cores should be considered for allocation. Additionally, such coordinating processor cores should be managed and selected such that clock speed, cache memory, and numbers are all considered.

In such instances, it is noted that performance during execution of Energy Components improves greatly with increased parallelism, indicating that performance is highly dependent upon processor performance. It is noted that other types of performance enhancements (e.g., increases in RAM or disk responsiveness) did not exhibit the same performance increases, therefore indicating that the post-processing of retrieved data from a hydrocarbon asset database represents a significant portion of the execution time of an Energy Components query.

It is noted in FIG. 6 that, even with low parallelism, use of covering indices in the hydrocarbon production asset database 310 also provides substantial performance advantages. In particular, in the experiment shown, use of covering indices provides similar performance to 16-core parallel execution without such indices. The combination of such covering indices and parallelism can reduce query execution time by a factor of four or more each (e.g., from about 160 seconds to about 40 seconds for use of parallelism without covering indices, and from about 40 seconds to less than 10 seconds for use of both 16-core parallelism and covering indices).

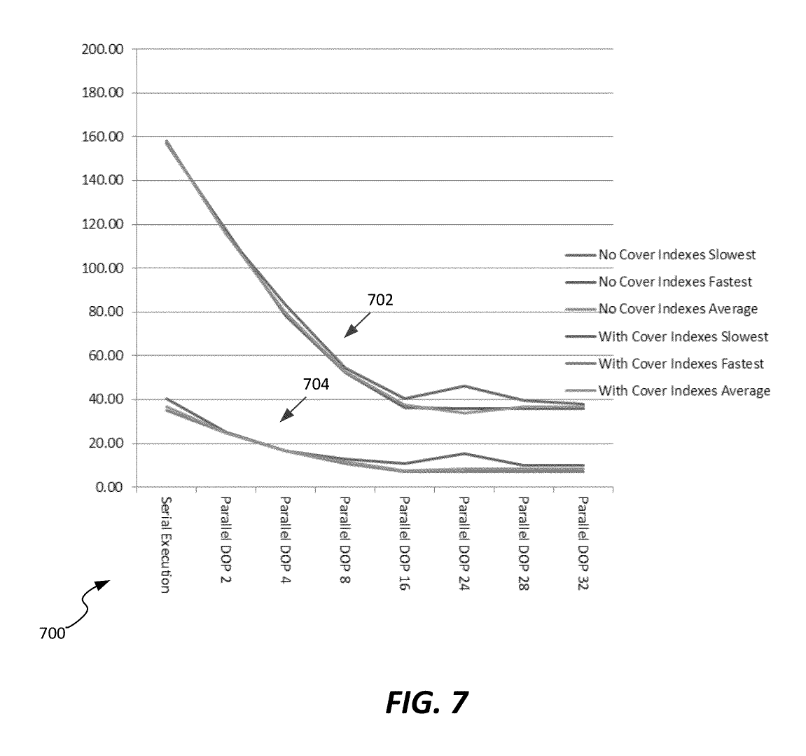

As shown in FIG. 7, a further chart 700 illustrates further details of different queries that are performed on a hydrocarbon production asset database 310, in the example experiments performed. In the example shown, fastest, slowest, and average queries were performed, both with and without cover indices (shown as line groups 702, 704, respectively). As illustrated in FIG. 7, the query performance did not differ greatly among these different queries, thereby illustrating that the difference between queries did not drastically change performance of the queries themselves. In other words, the identity of typical queries affected the time to execute the queries less than the level of parallelism and existence of covering indices.

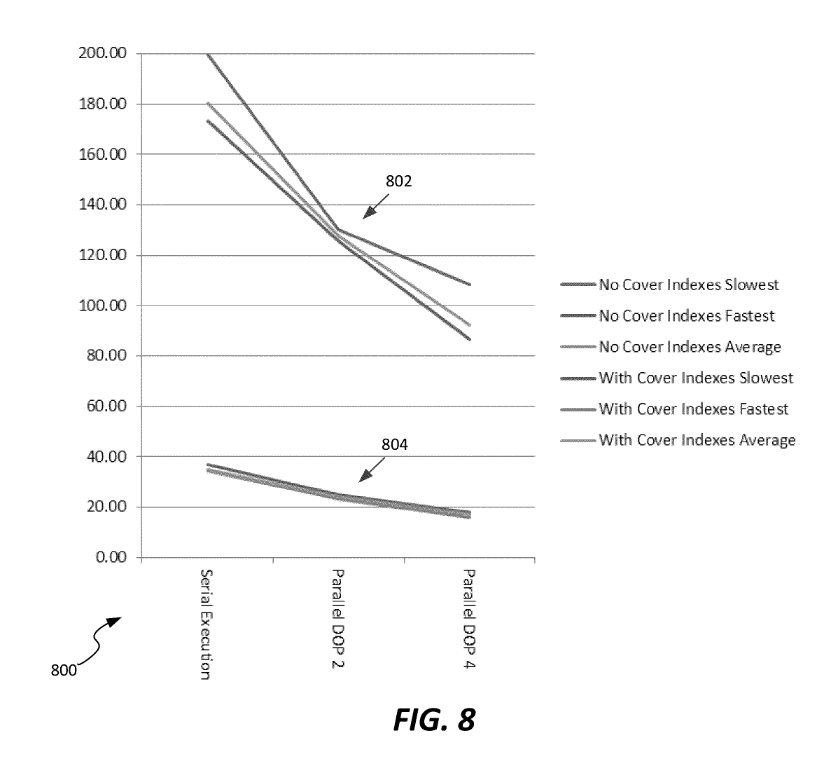

The example shown in a chart 800 of FIG. 8 illustrates a similar observation with respect to a different workload to reflect differences among reports that may be generated. Again, in chart 800, line groups 802, 804, respectively show that there is limited difference among fastest and slowest query execution, but that there is substantial performance advantage to be had by applying both covering indices and data parallelism to many different query and/or report types.

It is noted that, in performing the experiments of FIGS. 6-8, a number of other aspects of the computing system used to execute such queries were studied, but did not illustrate a strong performance advantage. For example, RAM amounts were studied but did not provide substantial performance advantages of the extent similar to the processing unit core count or parallelism features.

The above specification, examples and data provide a complete description of the manufacture and use of the composition of the invention. Since many embodiments of the invention can be made without departing from the spirit and scope of the invention, the invention resides in the claims hereinafter appended.

1. A hydrocarbon production tracking system comprising:
a computing system including:
a plurality of processing units;
a memory communicatively connected to the plurality of processing units, the memory storing computer-executable instructions which, when executed, cause the computing system to execute a hydrocarbon production tracking system application, the hydrocarbon production tracking system application executable to:
process and track historical data regarding a plurality of hydrocarbon production assets; and
receive and process a plurality of queries received at the computing system;
a hydrocarbon production asset database communicatively coupled to the plurality of processing units, the hydrocarbon production asset database including field operations data and formulas modeling field operations an organization over a lifetime of each of a plurality of hydrocarbon production assets associated with the organization;
wherein the computing system is configured such that at least one of the plurality of processing units executes a coordinating process and a remaining plurality of the processing units are configured to respond to the queries, wherein the queries are associated with the field operations data in the hydrocarbon production asset database; and
wherein the hydrocarbon production asset database includes at least one covering index, the covering index useable by the hydrocarbon production tracking system application to respond to the queries received at the computing system.

2. The hydrocarbon production tracking system of claim 1, wherein the plurality of processing units includes at least 16 processing cores.

3. The hydrocarbon production tracking system of claim 1, wherein the hydrocarbon production tracking system is configurable to, based at least in part on the at least one covering index, receive and process the queries received at the computing system relating to historical data in the hydrocarbon production asset database over a predetermined period of time.

4. The hydrocarbon production tracking system of claim 1, wherein the predetermined period of time comprises a lifetime of the plurality of different hydrocarbon production assets used by the organization.

5. The hydrocarbon production tracking system of claim 1, wherein the hydrocarbon production tracking system application is further configured to update data in the hydrocarbon production asset database on an at least daily basis.

6. The hydrocarbon production tracking system of claim 1, wherein the memory includes a Random Access Memory (RAM).

7. The hydrocarbon production tracking system of claim 1, wherein the hydrocarbon production tracking system application is configured to process queries by separating at least some of the queries into subtasks and assign each of the subtasks among a plurality of the processing units configured to respond to the queries.

8. The hydrocarbon production tracking system of claim 1, wherein two or more of the plurality of processing units are configured to execute a coordinating process.

9. The hydrocarbon production tracking system of claim 1, wherein in response to a query, the hydrocarbon production tracking system application is executable to present at least one view on data included in the hydrocarbon production asset database, the hydrocarbon production tracking system application generating the at least one view based on executing one or more functions included in the hydrocarbon production asset database that define data.

10. The hydrocarbon production tracking system of claim 1, wherein the hydrocarbon production tracking system application is configured to perform an analysis selected from a group consisting of:
an injection production profile;
a Hall plot;
a WaterFlood surveillance;
an asset trend report;
a fuel use report;
a nomination schedule, or combinations thereof.

11. A method of executing a hydrocarbon production tracking system application on a computing system, the method comprising:
receiving a query at the hydrocarbon production tracking system application executing on a computing system;
splitting, via the hydrocarbon production tracking system application, the query into a plurality of sub-tasks;
assigning the sub-tasks to each of a plurality of processing units of the computing system;
applying the sub-tasks to data included in a hydrocarbon production asset database, the hydrocarbon production asset database including field operations data and formulas modeling field operations an organization over a lifetime of each of a plurality of hydrocarbon production assets associated with the organization, the hydrocarbon production asset database including at least one covering index useable by the hydrocarbon production tracking system application to respond to the queries received at the computing system;
compiling results from each of the plurality of subtasks into results of the query;
generating one or more reports based on the results of the query.

12. The method of claim 11, further comprising executing a coordinating process using at least one processing unit of the computing system.

13. The method of claim 11, wherein the query relates to historical data in the hydrocarbon production asset database over a predetermined period of time.

14. The method of claim 11, wherein the one or more reports include at least one view on data included in the hydrocarbon production asset database, the hydrocarbon production tracking system application generating the at least one view based on executing one or more functions included in the hydrocarbon production asset database that define data.

15. The method of claim 11, wherein the at least one covering index includes a plurality of covering indices.

16. The method of claim 11, wherein the sub-tasks include simplified queries based on the query received at the hydrocarbon production tracking system application.

17. The method of claim 11, further comprising periodically updating data in the hydrocarbon production asset database.

18. The method of claim 17, wherein the periodic updating of data in the hydrocarbon production asset database occurs at least daily.

19. A computer-readable storage medium comprising computer-executable instructions which, when executed, performs a method of executing a hydrocarbon production tracking system application on a computing system, the method comprising:
receiving a query at the hydrocarbon production tracking system application executing on a computing system;
splitting, via the hydrocarbon production tracking system application, the query into a plurality of sub-tasks;
assigning the sub-tasks to each of a plurality of processing units of the computing system;
applying the sub-tasks to data included in a hydrocarbon production asset database, the hydrocarbon production asset database including field operations data and formulas modeling field operations an organization over a lifetime of each of a plurality of hydrocarbon production assets associated with the organization, the hydrocarbon production asset database including at least one covering index useable by the hydrocarbon production tracking system application to respond to the queries received at the computing system;
compiling results from each of the plurality of subtasks into results of the query;
generating one or more reports based on the results of the query.

20. The computer-readable storage medium of claim 19, wherein the computer-readable storage medium is included in a computer storage device.
